(19) United States
(12) Patent Application Publication
(10) Pub. No.: US 2010/0157190 A1
(43) Pub. Date: Jun. 24, 2010

(54) DISPLAY DEVICE

(75) Inventors: Jae-Han LEE, Asan-si (KR); Ok-Kwon SHIN, Cheonan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/547,849

(22) Filed: Aug. 26, 2009

(30) Foreign Application Priority Data
Dec. 19, 2008 (KR) 10-2008-0129969

(51) Int. Cl. G02F 1/1333

(52) U.S. Cl. 349/54

(57) ABSTRACT

A display device having a reduced repair line length and a reduced repair unit to reduce the wire resistance of the repair line and the repair unit. The display device includes: a single flexible circuit film; a circuit board connected to the flexible circuit film; and a thin film transistor array panel connected to the flexible circuit film and having a display area and a peripheral area enclosing the display area. The display device also includes a single driving circuit chip disposed on the flexible circuit film; a repair line and a repair bar disposed in the peripheral area of the thin film transistor array panel; a repair amplifier disposed on the driving circuit chip and connected to the repair line and the repair bar. A repair input line connects the repair bar and the repair amplifier and a repair output line connects the repair amplifier and the repair line.

### CROSS REFERENCE TO RELATED APPLICATION

This application claims priority from and the benefit of Korean Patent Application No. 10-2008-0129969, filed on Dec. 19, 2008, which is hereby incorporated by reference for all purposes as if fully set forth herein.

### BACKGROUND OF THE INVENTION

1. Field of the Invention

The present invention relates to a display device.

2. Discussion of the Background

Generally, a flat panel display, such as a liquid crystal display (LCD) and an organic light emitting diode (OLED) display, includes a plurality of pairs of field generating electrodes and an electro-optical activation layer disposed between each pair. The liquid crystal display includes a liquid crystal layer as the electro-optical activation layer, and the organic light emitting diode display includes an organic emission layer as the electro-optical activation layer.

One of the field generating electrodes out of each pair of field generating electrodes is generally connected to a switching element so as to receive an electrical signal, and the electro-optical activation layer converts the electrical signal to an optical signal to thereby display images.

In the flat panel display, a thin film transistor (TFT) including three terminals is used as the switching element. The flat panel display also includes a gate line, which transmits a scanning signal to control the thin film transistor, and a data line, which transmits a signal applied to a pixel electrode.

The flat panel display also includes a repair line and a repair unit to repair a signal line when a defect is generated on the signal line during the manufacturing process. Generally, the repair line and the repair unit are connected to a repair amplifier formed on a driving circuit film outside the display panel. When connecting the repair line and the repair unit to the driving circuit film outside the display panel, the length of the repair line and the repair unit may be elongated such that wire resistance is increased.

### SUMMARY OF THE INVENTION

Exemplary embodiments of the present invention provide reduced wire resistance of a repair line and a repair unit in a display device.

Additional features of the invention will be set forth in the description which follows, and in part will be apparent from the description, or may be learned by practice of the invention.

An exemplary embodiment of the present invention discloses a display device, which includes: one flexible circuit film; a circuit board connected to the flexible circuit film; and a thin film transistor array panel connected to the flexible circuit film and having a display area and a peripheral area enclosing the display area. The display device also includes one driving circuit chip formed in the flexible circuit film; a repair line and a repair bar formed in the peripheral area of the thin film transistor array panel; and a repair amplifier formed in the driving circuit and connected to the repair line and the repair bar. The display device also includes a repair input line connecting the repair bar and the repair amplifier; and a repair output line connecting the repair amplifier and the repair line.

Another exemplary embodiment of the present invention discloses a display device, which includes: one flexible circuit film; a circuit board connected to the flexible circuit film; and a thin film transistor array panel connected to the flexible circuit film and having a display area and a peripheral area enclosing the display area. The display device also includes one driving circuit chip formed in the peripheral area of the thin film transistor array panel; a repair line and a repair bar formed in the peripheral area of the thin film transistor array panel; and a repair amplifier formed in the driving circuit and connected to the repair line and the repair bar. The display device also includes a repair input line connecting the repair bar and the repair amplifier; and a repair output line connecting the repair amplifier and the repair line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic layout view of a display device according to an exemplary embodiment of the present invention.

FIG. 2 is a detailed view showing a portion of the display device shown in FIG. 1.

FIG. 3 is a view showing a repair process of a display device according to an exemplary embodiment of the present invention.

FIG. 4 is a schematic layout view of a display device according to another exemplary embodiment of the present invention.

### DETAILED DESCRIPTION OF THE EMBODIMENTS

The present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

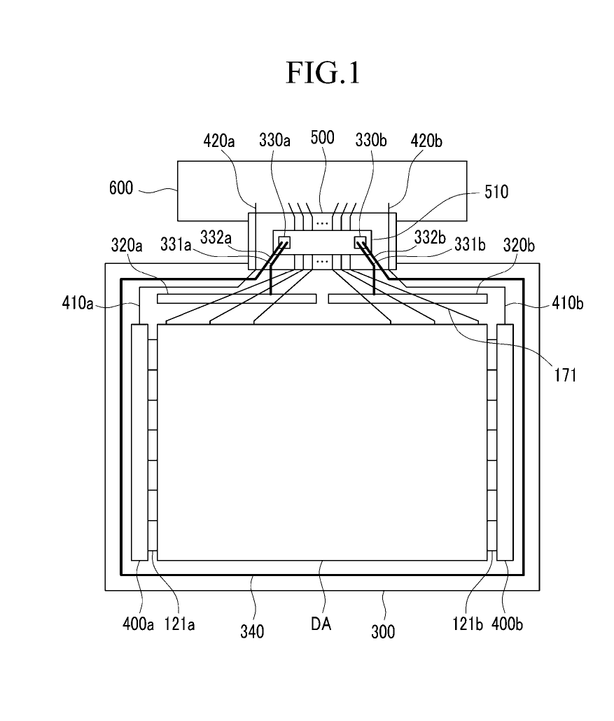

Firstly, a display device according to an exemplary embodiment of the present invention will be described with reference to FIG. 1. FIG. 1 is a schematic layout view of a display device according to an exemplary embodiment of the present invention.

As shown in FIG. 1, a display device according to an exemplary embodiment of the present invention includes a display panel assembly 300 having a peripheral area enclosing a display area DA. The display device also includes a first gate driver 400a and a second gate driver 400b formed in the peripheral area of the display panel assembly 300, a first repair bar 320a and a second repair bar 320b, a first repair input line 331a and a second repair input line 331b, and a first repair output line 332a and a second repair output line 332b. As shown in the illustrated embodiment, the display device also includes a repair line 340 connected to the first repair output line 332a and the second repair output line 332b, and a first gate driving signal line 410a and a second gate driving signal line 410b connected to the first gate driver 400a and the second gate driver 400b, respectively. The display device also includes a driving circuit film 500 connected to the display panel assembly 300, a circuit board 600 connected to the driving circuit film 500, and gate leads 420a and 420b formed on the outer portion of the right and left sides of the driving circuit film 500 for connecting the first gate driver 400a and the second gate driver 400b, respectively, to the circuit board 600. The first gate driver 400a and the second gate driver 400b are connected to first gate lines 121a and second gate lines 121b, respectively.

The driving circuit film 500 includes a data driving circuit chip 510, and a first repair amplifier 330a and a second repair amplifier 330b are formed in the data driving circuit chip 510. The display device according to an exemplary embodiment of the present invention includes one data driving circuit chip 510 having the first repair amplifier 330a and the second repair amplifier 330b operable to simultaneously transmit a repair signal when the data signal is transmitted.

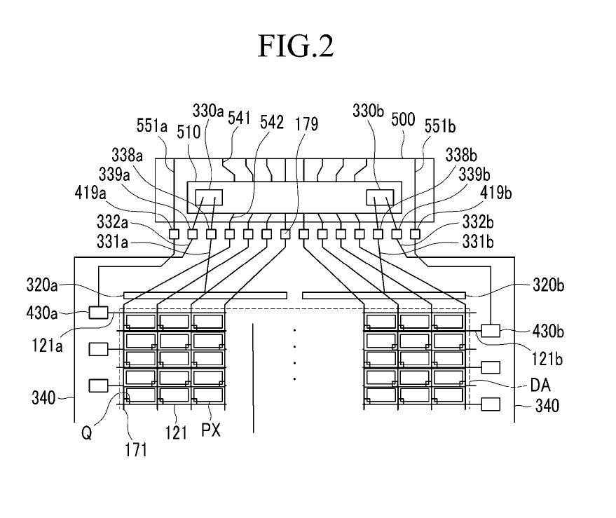

Next, a display device according to an exemplary embodiment of the present invention will be described in detail with reference to FIG. 2. FIG. 2 is a detailed view of a portion of the display device of FIG. 1.

Firstly, the display area DA will be described.

Referring to FIG. 2, a plurality of gate lines 121 including a plurality of first gate lines 121a and a plurality of second gate lines 121b and a plurality of data lines 171, that are insulated from each other and cross each other, and a plurality of pixel electrodes PX connected thereto and arranged in a matrix shape, are formed in the display area DA of the display panel assembly 300.

The gate lines 121 transmit gate signals (referred to as “scanning signals”) and extend substantially in a row direction, are spaced apart from each other in a column direction and are substantially parallel to each other, and the data lines 171 transmit data signals and extend substantially in a column direction, are spaced apart from each other in a row direction and are substantially parallel to each other.

A switching element Q is disposed at each pixel at a position where respective gate lines 121 and data lines 171 cross each other.

The switching element Q, as a three terminal element such as a thin film transistor, includes a control terminal connected to the gate line 121, an input terminal connected to the data line 171, and an output terminal connected to the pixel electrode PX.

Three pixel electrodes PX that are neighboring in the direction that the data line 171 is extended form one dot as a basic unit to display an image. Each pixel electrode PX forming the dot is connected to a different gate line 121, and the pixel electrodes PX are alternately connected to one of two neighboring data lines 171 disposed on the left and right sides of the pixel electrodes PX in the direction of the data line 171.

Each pixel electrode PX includes four main edges parallel to the gate line 121 or the data line 171 and has a substantially quadrangle shape. Of the pixel electrode PX main edges, two transverse edges parallel to the gate line 121 are longer than two longitudinal edges parallel to the data line 171, by approximately three times. Accordingly, compared with an embodiment in which the transverse edge is smaller than the longitudinal edge, the number of pixel electrodes PX disposed in each row is small and the number of the pixel electrodes PX disposed in each column is large. Accordingly, the entire number of data lines 171 is reduced such that the number of integrated circuit (IC) chips for the data driver 500 is reduced, thereby reducing the material cost. Of course, although the number of gate lines 121 is increased, the gate drivers 400a and 400b are integrated into the display panel 300 assembly along with the gate lines 121, the data lines 171, and the thin film transistors such that it is not a problem to increase the number of gate lines 121. FIG. 2 is one example of the structure of the signal lines and the pixels disposed in the display area DA of the display device according to the present exemplary embodiment; however the present invention may be applied to a display device having a different shape of signal lines and pixels.

Next, the peripheral area will be described.

The peripheral area includes a first shift resist 430a included in the first gate driver 400a, a second shift resist 430b included in the second gate driver 400b, the first repair bar 320a, the second repair bar 320b, the first repair input line 331a, the second repair input line 331b, the first repair output line 332a and the second repair output line 332b. The first repair output line 332a and the second repair output line 332b are connected to the repair line 340, and the first gate driving signal line 410a and the second gate driving signal line 410b are connected to the first shift resist 430a and the second shift resist 430b, respectively, in the peripheral area. Also, in the peripheral area, the first repair bar 320a and the second repair bar 320b are disposed on the left and right sides of the display panel assembly 300, respectively. As shown in the illustrated embodiment, the first repair input line 331a, the second repair input line 331b, the first repair output line 332a, the second repair output line 332b, the repair line 340 connected to the first repair output line 332a and the second repair output line 332b, and a plurality of pads 179, 338a, 338b, 339a, 339b, 419a, and 419b are disposed in the peripheral area.

The first gate driver 400a and the second gate driver 400b are disposed on the left and right sides with reference to the display area DA in the illustrated embodiment. However, the display device according to another exemplary embodiment of the present invention may include one gate driver disposed on one of the right and left sides of the display area.

The first gate driving signal line 410a and the second gate driving signal line 410b are disposed on the left side and the right side, respectively, with reference to the display area DA, and are each connected to a respective gate lead 551a and 551b formed on the outer portion of the left side and the right side of the driving circuit film 500 through the first gate driving pad 419a and the second gate driving pad 419b. The first gate driving signal line 410a and the second gate driving signal line 410b are connected to the circuit board 600 through the respective gate leads 551a and 551b, such that they receive the gate driving signal from the circuit board 600 to transmit the gate driving signal to the first gate driver 400a and the second gate driver 400b, respectively.

On the other hand, the display device according to an exemplary embodiment of the present invention includes one driving circuit film 500, and the driving circuit film 500 includes one driving circuit chip 510 and a plurality of first data leads 541 and a plurality of second data leads 542 extend from the driving circuit chip 510. The first data leads 541 are connected to the circuit board 600, and the second data leads 542 are connected to the data pads 179 connected to the data lines 171. Each data line 171 is applied with the data signal from the driving circuit chip 510 through the respective second data lead 542.

The first repair amplifier 330a and the second repair amplifier 330b are formed on the left side and the right side, respectively, of the driving circuit chip 510 in the illustrated embodiment. The first repair amplifier 330a and the second repair amplifier 330b each include an operational amplifier (OP-AMP).

The first repair bar 320a and the second repair bar 320b are disposed on the left side and right side of the display panel assembly 300, respectively, and the first repair input line 331a and the second repair input line 331b are respectively connected to the first repair bar 320a and the second repair bar 320b and are likewise disposed on the left side and the right side of the display panel assembly 300, respectively. The first repair input line 331a and the second repair input line 331b are respectively connected to the first repair amplifier 330a and the second repair amplifier 330b disposed on the left and right sides of the driving circuit chip 510. The first repair output line 332a and the second repair output line 332b are connected to the first repair amplifier 330a and the second repair amplifier 330b, respectively and each of the first repair output line 332a and the second repair output line 332b are connected to the repair line 340.

The first repair bar 320a is connected to the first repair amplifier 330a through the first repair input line 331a and the second repair bar 320b is connected to the second repair amplifier 330b through the second repair input line 331b. The first repair input pad 338a and the first repair amplifier 330a are connected to the repair line 340 through the first repair output line 332a and the first repair output pad 339a. The second repair input pad 338b and the second repair amplifier 330b are connected to the repair line 340 through the second repair output line 332b and the second repair output pad 339b. The first repair bar 320a, the second repair bar 320b, the first repair input line 331a, the second repair input line 331b, the first repair output line 332a, and the second repair output line 332b may be insulated from the first gate driving signal line 410a and the second gate driving signal line 410b via an insulating layer interposed therebetween, and may overlap a plurality of data lines 171 via the insulating layer interposed therebetween.

Through these elements, in the repair, the repair signal is passed through the first repair bar 320a and the second repair bar 320b, and arrives at the first repair amplifier 330a and the second repair amplifier 330b formed in the driving circuit chip 510 through the first repair input line 331a and the second repair input line 331b, and the arrived repair signal is amplified and transmitted to the repair line 340 through the first repair output line 332a and the second repair output line 332b, and then is transmitted to the lower portion of the display device through the peripheral area. In the present exemplary embodiment, the repair line 340 is connected to the first repair output line 332a and the second repair output line 332b thereby having a shape enclosing the peripheral area, however in another exemplary embodiment the repair line 340 may be divided in the peripheral area to include two repair lines where one is disposed on the right side and the other is disposed on the left side of the display panel assembly 300 under the display area DA shown in FIG. 1. In this embodiment, the length of the repair line may be further reduced.

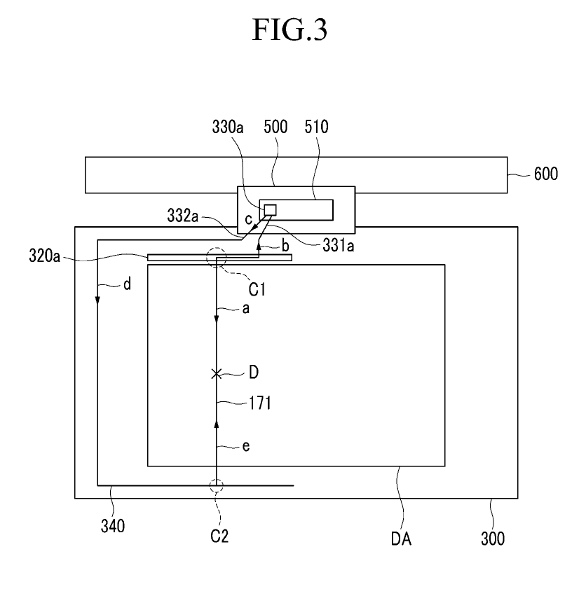

Next, a repair process according to an exemplary embodiment of the present invention will be described with reference to FIG. 3. In FIG. 3, the transmission of the data signal is indicated by an arrow.

In a manufacturing process of the display device, when a defect is generated in a portion of a data line 171 among the plurality of data lines 171 at a position D, the data signal may be transmitted from the data pad 179 to the defect position D, however the data signal is not transmitted below this.

In this case, the data line 171 and the first repair bar 320a that overlap each other via the insulating layer interposed therebetween are shorted by using a laser at the position C1 where the data line 171 and the first repair bar 320a are crossed.

Also, the data line 171 and the repair line 340 that overlap each other via the insulating layer interposed therebetween are shorted by using the laser at the position C2 where the data line 171 and the repair line 340 are crossed under the display area DA.

Through this repair process, the data signal is transmitted from the data pad 179 to the defect position D (a), and is simultaneously passed through the first repair input line 331a through the first repair bar 320a (b), and arrives at the first repair amplifier 330a. The first repair amplifier 330a amplifies the repair signal, the amplified repair signal passes through the first repair output line 332a (c), is transmitted through the repair line 340 (d), and is transmitted from the position C2 to the position D through the repair line 340 and the shorted data line 171 (e). Accordingly, the data signal may be transmitted to the upper and lower portions of the position D.

The repair amplifier of the display device according to an exemplary embodiment of the present invention is not formed in the circuit board 600, but is formed in the driving circuit chip 510 of the driving circuit film 500. Accordingly, it is not necessary for the signal line transmitting repair signal to be connected to the circuit board 600 such that the length of the repair signal line is reduced and the wire resistance of the repair unit may be reduced, thereby improving the repair efficiency. Also, it is not necessary for the lead line for connecting the repair signal line to the circuit board 600 to be formed in the driving circuit film 500 such that the manufacturing cost of the driving circuit film 500 may be reduced.

The display device according to the present exemplary embodiment includes the first repair bar 320a disposed on the left side of the display panel assembly 300 and the second repair bar 320b disposed on the right side of the display panel assembly 300, however in another exemplary embodiment, the display device may include one repair bar. Also, in the present exemplary embodiment, the repair line 340 is connected to the first repair output line 332a and the second repair output line 332b such that the repair line 340 has a shape enclosing the peripheral area, however the repair line 340 may be divided under the display area DA to include two repair lines, one disposed on the right side and the other disposed on the left side of the display panel assembly 300, and in this case, the length of the repair line may be further reduced.

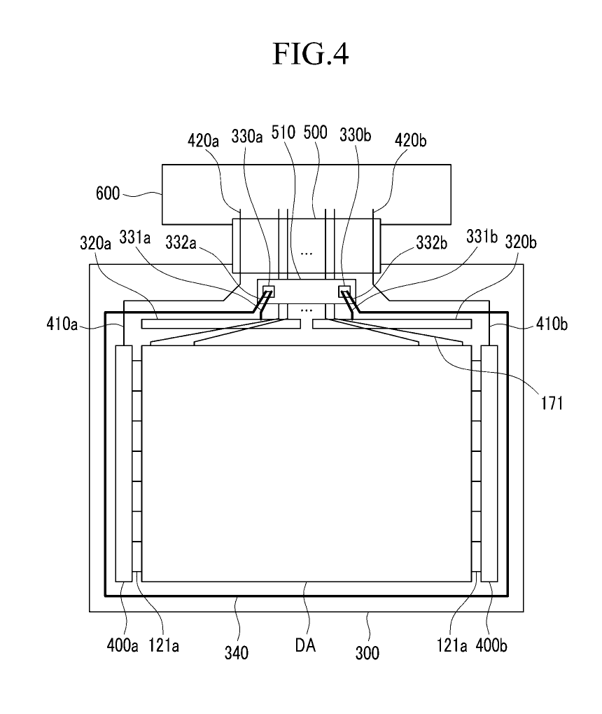

Next, a display device according to another exemplary embodiment of the present invention will be described with reference to FIG. 4. FIG. 4 is a schematic layout view of a display device according to another exemplary embodiment of the present invention.

As shown in FIG. 4, the display device according to the present exemplary embodiment is similar to the arrangement of the display device shown in FIG. 1.

The display device according to the present exemplary embodiment includes a display panel assembly 300 having a display area DA and a peripheral area enclosing the periphery thereof. The first gate driver 400a and the second gate driver 400b are formed in the peripheral area of the display panel assembly 300. The display device also includes the first repair bar 320a, the second repair bar 320b, the first repair input line 331a, the second repair input line 331b, the first repair output line 332a, and the second repair output line 332b. The repair line 340 is connected to the first repair output line 332a and the second repair output line 332b. The first gate driving signal line 410a and the second gate driving signal line 410b are connected to the first gate driver 400a and the second gate driver 400b, respectively. The display device also includes the first repair amplifier 330a and the second repair amplifier 330b connected to one data driving circuit chip 510, a flexible circuit film 500 connected to the display panel assembly 300, a circuit board 600 connected to the driving circuit film 500, and gate leads 420a and 420b formed on the outer portion of the left and right sides of the driving circuit film 500 for connecting the first gate driver 400a and the second gate driver 400b, respectively, to the circuit board 600. The first gate driver 400a and the second gate driver 400b are directly connected to first gate lines 121a and second gate lines 121b, respectively.

However, differently from the display device of FIG. 1, the data driving circuit chip 510 and the first repair amplifier 330a and the second repair amplifier 330b of the present illustrated embodiment are not formed on the flexible circuit film 500, but are formed on the substrate of the display panel assembly 300.

Further, the repair amplifier of the display device according to an exemplary embodiment of the present invention is not formed on the circuit board 600, but is formed on the substrate of the display panel assembly 300. Accordingly, it is not necessary for the signal line transmitting the repair signal to be connected to the circuit board 600 such that the length of the repair signal line is reduced, thereby reducing the wire resistance of the repair unit and improving the repair efficiency. Also, it is not necessary for the lead line for connecting the repair signal line to the circuit board 600 to be formed in the driving circuit film 500 such that the manufacturing cost of the driving circuit film 500 may be reduced.

The display device according to the present exemplary embodiment may be applied to all flat panel displays including the thin film transistor array panel having the thin film transistor as well as the liquid crystal display and the organic light emitting device.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a single flexible circuit film;
a circuit board connected to the flexible circuit film;
a thin film transistor array panel connected to the flexible circuit film, and having a display area and a peripheral area enclosing the display area;
a single driving circuit chip disposed on the flexible circuit film;
a repair line and a repair bar disposed in the peripheral area of the thin film transistor array panel;
a repair amplifier disposed on the driving circuit chip, and connected to the repair line and the repair bar;
a repair input line connecting the repair bar and the repair amplifier; and
a repair output line connecting the repair amplifier and the repair line.

2. The display device of claim 1, wherein
the repair amplifier comprises a first repair amplifier and a second repair amplifier formed on respective sides of the driving circuit chip.

3. The display device of claim 2, wherein:
the repair bar comprises a first repair bar disposed on the left side of the display device and a second repair bar disposed on the right side of the display device; and
the first repair bar is connected to the first repair amplifier, and the second repair bar is connected to the second repair amplifier.

4. The display device of claim 3, wherein
the repair line comprises a first portion connected to the first repair amplifier and a second portion connected to the second repair amplifier.

5. The display device of claim 1, wherein
the display area comprises:
a plurality of gate lines;
a plurality of data lines; and
a plurality of pixel electrodes,
wherein the pixel electrodes each have a first edge parallel to the gate lines and a second edge parallel to the data lines, and
the first edge is longer than the second edge.

6. The display device of claim 5, wherein
a length of the first edge is three times a length of the second edge.

7. A display device, comprising:
a single flexible circuit film;
a circuit board connected to the flexible circuit film;
a thin film transistor array panel connected to the flexible circuit film, and having a display area and a peripheral area enclosing the display area;
a single driving circuit chip disposed in the peripheral area of the thin film transistor array panel;
a repair line and a repair bar disposed in the peripheral area of the thin film transistor array panel;
a repair amplifier disposed on the driving circuit chip, and connected to the repair line and the repair bar;
a repair input line connecting the repair bar and the repair amplifier; and
a repair output line connecting the repair amplifier and the repair line.

8. The display device of claim 7, wherein
the repair amplifier comprises a first repair amplifier and a second repair amplifier formed on respective sides of the driving circuit chip.

9. The display device of claim 8, wherein:
the repair bar comprises a first repair bar disposed on the left side of the display device and a second repair bar disposed on the right of the display device; and
the first repair bar is connected to the first repair amplifier and the second repair bar is connected to the second repair amplifier.

10. The display device of claim 9, further comprising:
a repair input line connecting the repair bar to the repair amplifier; and
a repair output line connecting the amplifier to the repair line.

11. The display device of claim 8, wherein
the repair line comprises a first portion connected to the first repair amplifier, and a second portion connected to the second repair amplifier.

12. The display device of claim 7, wherein
the display area comprises:
a plurality of gate lines;
a plurality of data lines; and
a plurality of pixel electrodes,
wherein the pixel electrodes have a first edge parallel to the gate lines and a second edge parallel to the data lines, and
the first edge is longer than the second edge.
